(19) United States
(12) Patent Application Publication
(10) Pub. No.: US 2015/0056480 A1
(43) Pub. Date: Feb. 26, 2015

(54) METHODS FOR DENDRITE DETECTION AND BATTERIES CONTAINING DENDRITE SENSORS

(71) Applicant: Lockheed Martin Corporation, Bethesda, MD (US)

(72) Inventors: James L. LEE, Elbert, CO (US); Edward Henry Allen, Bethesda, MD (US)

(21) Appl. No.: 14/469,441

(22) Filed: Aug. 26, 2014

Related U.S. Application Data
(60) Provisional application No. 61/870,133, filed on Aug. 26, 2013.

(51) Int. Cl. H01M 10/48; H01M 10/0525

(52) U.S. Cl. CPC H01M 10/48; H01M 10/0525
USPC 429/50; 429/90; 429/61

(57) ABSTRACT

Formation of metallic dendrites within a battery can lead to catastrophic batten failure in some instances. Methods for monitoring for the presence of metallic dendrites within a battery can include measuring the electric field within the battery's separator material over a period of time. Batteries containing an electric field sensor on or in their separator material can be fabricated and their operation regulated in the event of dendrite formation. The electric field sensor is configured to detect an electric field in the separator material.

### CROSS-REFERENCE TO RELATED APPLICATIONS

This application claims the benefit of priority under 35 U.S.C. §119 from U.S. Provisional Patent Application 61/870,133, filed Aug. 26, 2013 is incorporated herein by reference in its entirety.

### STATEMENT REGARDING FEDERALLY SPONSORED RESEARCH OR DEVELOPMENT

Not applicable.

### FIELD

The present disclosure generally relates to batteries, and, more specifically, to methods for assaying for the presence of metallic dendrites in batteries.

### BACKGROUND

Typical lithium-ion batteries utilize carbon anodes and lithiated transition metal oxide cathodes separated by a separator material. These batteries currently dominate the battery market in the area of cellular phones, cameras, computers, and other electronic equipment. Problematic areas for these batteries, particularly in rugged applications, include safety, life span, and cost.

One source of failure in lithium-ion batteries is the formation of dendrites within the battery. Dendrites are microscopic metal deposits that can form within the cell. Known causes of dendrite formation include manufacturing defects, over charging, and rapid charge at cold temperatures. Dendrite formation generally begins in the negative electrode and creates an internal short when it extends through the separator to the positive electrode. This short can lead to a catastrophic battery failure. Although the cause of recent Boeing 787 fires has not yet been determined, there has been some speculation that they resulted from dendrites. There is currently no method to reliably detect the presence of dendrites within a battery.

In view of the foregoing, batteries incorporating dendrite detection technology and methods for detecting dendrites would represent a substantial advance in the art. The present disclosure satisfies these needs and provides related advantages as well.

### SUMMARY

In some embodiments, the present disclosure describes batteries containing an electric field sensor configured to detect an electric field in their separator material. In some embodiments, the batteries include a cathode and an anode having a separator material disposed therebetween, and a plurality of electric field sensors configured to detect an electric field in the separator material.

In some embodiments, the present disclosure describes methods for sensing dendrites using electric field detection and monitoring the changes thereof. In some embodiments, the methods include providing a battery having a cathode, an anode, and a separator material disposed therebetween, contacting a plurality of electric field sensors with the separator material, and measuring an electric field in the battery using the electric field sensors.

The foregoing has outlined rather broadly the features of the present disclosure in order that the detailed description that follows can be better understood. Additional features and advantages of the disclosure will be described hereinafter, which form the subject of the claims.

### BRIEF DESCRIPTION OF THE DRAWINGS

For a more complete understanding of the present disclosure, and the advantages thereof reference is now made to the following descriptions to be taken in conjunction with the accompanying drawings describing specific embodiments of the disclosure, wherein:

FIG. 1 shows a schematic of a battery containing an electric field sensor on or in the separator material.

### DETAILED DESCRIPTION

The present disclosure is directed, in part, to batteries having an electric field sensor on or in their separator material. The present disclosure is also directed, in part, to methods for sensing the formation of dendrites in a battery by detecting and monitoring an electric field formed therein over time.

The presence of a metallic dendrite increases the electric field intensity near the tip of the dendrite. The present inventors recognized that by deploying sensors in or on the separator material of a battery the growth and incursion of dendrites therein can be monitored, Specifically, such sensors can allow for the detection of changes in the electric field intensity over a prolonged period of time, particularly in the separator material of the battery. Detecting the presence of dendrites in the separator material can allow a battery management system to shut down the cell before the dendrites reach the positive electrode and therefore ran prevent a potentially catastrophic internal short. In addition to increasing battery safety, this approach may also provide insight into the state of health of the battery by monitoring the change in the cell operation over time.

In some embodiments, batteries described herein include a cathode and an anode having a separator material disposed therebetween, and a plurality of electric field sensors configured to detect an electric field in the separator material.

In some embodiments, the electric field sensors are in contact with the separator material. In some embodiments, the electric field sensors are disposed on a surface of the separator material. In other embodiments, the electric field sensors are disposed within the separator material.

In some embodiments, the batteries of the present disclosure can also include a controller configured to monitor and regulate their operation. In some embodiments, the controller can be communicatively coupled to the electric field sensors. The communicative coupling can be a direct wired connection or a wireless connection.

By being communicatively coupled to the electric field sensors, the controller can change an operational state of the battery upon detecting the presence of dendrites therein.

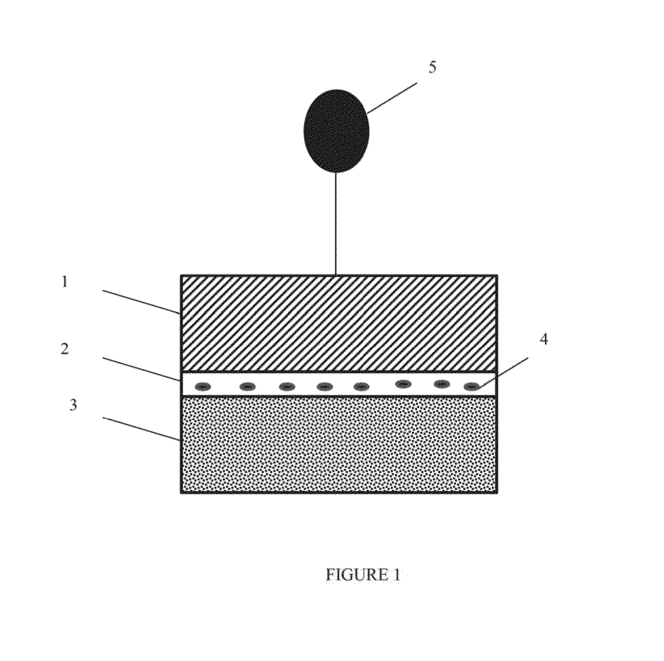

FIG. 1 shows a schematic of a battery containing an electric field sensor on or in the separator material. As shown in FIG. 1, cathode 1 and anode 3 are separated by separator material 2. Separator material 2 contains a plurality of electric field sensors 4 disposed On or in the separator material. Although FIG. 1 has depicted electric field sensors 4 as discrete entities, they can also be a continuous, monolithic sensor, if desired. Suitable electric field sensors are not believed to be particularly limited in function or structure, as long as they can be satisfactorily deployed on or in the separator material. The battery can also contain controller to monitor and regulate the operation of the battery in the event that the occurrence of dendrites is detected.

In some embodiments, the battery can be a lithium-ion battery. The battery can contain a lithium salt electrolyte and a non-aqueous solvent, as conventionally used in lithium-ion batteries. Suitable lithium salts can include, for example, LiClO₄, LiBF₄, LiAsF₆, LiPF₆, LiCF₃SO₃, Li(CF₃SO₂)₂N, Li(CF₃SO₂)₃C, LiN(SO₂C₂F₅)₂, lithium alkyl fluorophosphates, lithium bis(oxalato)borate (LiBOB), and any combination thereof.

Organic solvents used in non-aqueous electrolytes are generally aprotic organic solvents having a high dielectric constant illustrative organic solvents that can be used in a non-aqueous electrolyte include, without limitation, alkyl carbonates (e.g., propylene carbonate, ethylene carbonate, butylene carbonate, dimethyl carbonate, diethyl carbonate, dipropyl carbonate, methyl ethyl carbonate, methyl butyl carbonate, methyl propyl carbonate, ethyl propyl carbonate, butyl propyl carbonate, 1,2-butylene carbonate, 2,3-butylene carbonate, 1,2-pentene carbonate, and 2,3-pentene carbonate), nitriles (e.g., acetonitrile, acrylonitrile, propionitrile, butyronitrile and benzonitrile), sulfoxides (e.g., dimethyl sulfoxide, diethyl sulfoxide, ethyl methyl sulfoxide, and benzylmethyl sulfoxide), amides (e.g., formamide, methylformamide, and dimethylformamide), pyrrolidones (e.g., N-methylpyrrolidone), lactones (e.g., γ-butyrolactone, γ-valerolactone, 2-methyl-γ-butyrolactone, and acetyl-γ-butyrolactone), phosphate triesters, nitromethane, ethers (e.g., 1,2-dimethoxyethane; 1,2-diethoxyethane; 1,2-methoxyethoxyethane; 1,2- or 1,3-dimethoxypropane; 1,2- or 1,3-diethoxypropane; 1,2- or 1,3-othoxymethoxypropane; 1,2-dibutoxyethane; tetrahydrofuran; 2-methyltetrahydrofuran and other alkyl, dialkyl, alkoxy or dialkoxy tetrahydrofurans; 1,4-dioxane; 1,3-dioxolane; 1,4-dioxolane; 2-methyl-1,3-dioxolane; 4-methyl-1,3-dioxolane; sulfolane; 3-methysulfolane; methyl ether; ethyl ether; propyl ether; diethylene glycol dialkyl ether; triethylene glycol dialkyl ethers; ethylene glycol dialkyl ethers; and tetraethylene glycol dialkyl ethers), esters (e.g., alkyl propionates such as methyl or ethyl propionate, dialkyl malonates such as diethyl malonate, alkyl acetates such as methyl acetate and ethyl acetate, and alkyl formates such as methyl formate and ethyl formate); and maleic anhydride.

The separator material is not believed to be particularly burned and can be formed from any porous dielectric material having a sufficient porosity to promote ion mobility between the cathode and the anode when the battery is charging or discharging. In some embodiments, the separator material can include polymers such as polyethylene, polypropylene, polyester, and polyacrylonitrile. In some embodiments, the separator material can be a porous poly(vinylidene fluoride)-hexafluoropropane copolymer film, a porous cellulose film, kraft paper, rayon woven fabrics, and the like. In various embodiments, the thickness of the separator material can be about 100 microns or less. The electric, field sensors can be deployed in the separator material during its formation or on the separator material during fabrication of the battery.

Present approaches for identifying the presence of dendrites within a battery include optical sensors and optical fibers, external strain gauges, thin-film temperature sensing, gas monitoring, and laser-guided ultrasonic inspection. However, these approaches are still in the developmental stage and are much more problematic to implement than the embodiments described herein.

More specifically, methods for sensing metallic dendrites including measuring an electric field in a battery and its changes over time. In some embodiments, methods described herein include providing a battery having a cathode, an anode, and a separator material disposed therebetween, contacting a plurality of electric field sensors with the separator material, and measuring an electric field in the battery using the electric field sensors. In various embodiments, the electric field is measured in the separator material.

In various embodiments, measuring the electric field can involve determining a change in the electric field as a function of time. The change in the electric field as a function of time can be correlated to an incursion of one or more metallic dendrites into the separator material. In some embodiments, the methods described herein can further include regulating an operational state of the battery upon the incursion of one or more metallic dendrites into the separator material. Regulation of the operational state of the battery can take place using the controller described above,

Although the invention has been described with reference to the disclosed embodiments, those skilled in the art will readily appreciate that these are only illustrative of the invention. It should be understood that various modifications can be made without departing from the spirit of the invention. The invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

1. A battery comprising:
a cathode and an anode having a separator material disposed therebetween; and
a plurality of electric field sensors configured to detect an electric field in the separator material.

2. The battery of claim 1, wherein the electric field sensors are in contact with the separator material.

3. The battery of claim 2, wherein the electric field sensors are disposed on a surface of the separator material.

4. The battery of claim 2, wherein the electric field sensors are disposed within the separator material.

5. The battery of claim 1, further comprising:
a controller configured to monitor and regulate the operation of the battery.

6. The battery of claim 5, wherein the controller is communicatively coupled to the electric field sensors.

7. The battery of claim 1, wherein the battery comprises a lithium-ion battery.

8. A method comprising:
providing a battery comprising a cathode, an anode, and a separator material disposed therebetween;
contacting a plurality of electric field sensors with the separator material; and
measuring an electric field in the battery using the electric field sensors.

9. The method of claim 8, wherein the electric field is measured in the separator material.

10. The method of claim 8, wherein measuring the electric field in the battery comprises determining a change in the electric field as a function of time.

11. The method of claim 10, further comprising:
correlating the change in the electric field as a function of time to an incursion of one or more metallic dendrites into the separator material.

12. The method of claim 11, further comprising:
regulating an operational state of the battery upon the incursion of one or more metallic dendrites into the separator material.

13. The method of claim 8, wherein the electric field sensors are disposed on a surface of the separator material.

14. The method of claim 8, wherein the electric field sensors are disposed within the separator material.

15. The method of claim 8, wherein the battery comprises a lithium-ion battery.
